(19) United States
(12) Patent Application Publication
(10) Pub. No.: US 2015/0076731 A1
(43) Pub. Date: Mar. 19, 2015

(54) METHOD AND APPARATUS FOR WALL MOUNTING A SKULL WITH ADJUSTABLE ANTLER ORIENTATION

(71) Applicant: C. Owen Walton, JR., Waverly, AL (US)

(72) Inventor: C. Owen Walton, JR., Waverly, AL (US)

(21) Appl. No.: 14/029,795

(22) Filed: Sep. 18, 2013

(51) Int. Cl. A01N 1/00

(52) U.S. Cl. CPC A01N 1/00
USPC 264/242

(57) ABSTRACT

This invention relates to: A plastic or synthetic deer skull, molded from a real bone deer skull, having a ball and socket system molded into the antler pedicle for attaching the antlers to the skull. This system allows the antlers to be attached, rotated and adjusted in all directions, and locked into position. This invention also relates to a system of hanging the skull on a wall at approximately 45 degree angle, giving the antlers a more desirable and natural appearance. This invention also relates to methods of manufacturing the skull.

### CROSS-REFERENCE TO RELATED APPLICATIONS

This application claims the benefit of U.S. provisional patent application No. 61/702,235 filed Sep. 17, 2012 by C. Owen Walton, Jr., and incorporated in its entirety by reference herein.

### BACKGROUND OF THE INVENTION

This invention relates to improved apparatus and method for wall-mounting a deer skull with antlers, either or both of which may be hunting trophies or realistic looking replicas thereof. The hereindisclosed improvements improve the appearance of the product while also being more cost-effective to produce.

Other attempts have been made to do this with little success. One such attempt is an unreal looking, two piece, plastic skull with two square holes in the top where the antlers would go, with two square rods that slide into the holes. It is instructed to attach the antlers to the rods and put the rod into the holes in the skull. The product has no adjustment to the antlers after they are attached therefore making the antlers look very unreal, particularly when the assembly is wall-mounted.

Another attempt is an unreal looking skull with two pegs stuck out the top, and instructions to attach antlers on the pegs. This product has no adjustment to the antlers after they are attached, making the antlers look unnatural.

Another attempt is a real looking skull but has no effective way to attach antlers to the skull. The user is instructed to drill a hole in the skull and in the antlers and glue a rod in the holes. This skull looks fairly good but does not have an effective way to adjust antlers after attached.

An attempt to make antlers adjustably attached to a skull is to make a “skull plate” (just the portion of a skull where antlers are attached) that could be adjusted. This may be an aluminum object made from short pieces of angle stock held together with nuts and bolts. By loosening and tightening the nuts and bolts one can turn and adjust antlers in different directions, but it does not work very well. The way the antlers attach to this is also very ineffective, plus the skull plate is not real looking, so it has to be built up and covered with clay when used by attaching it to a skull.

Another attempt to make an adjustable skull plate is a aluminum object with two vertical pipes attached to a base. Two balls with rods slide up and down in the pipes to give it some adjustment, but it does not look real at all, and has to be built up and covered with clay when used.

A “European Skull Mount” is a way for a hunter to preserve his trophy at somewhat less cost than the traditional way of mounting the head. Most standard head mounts today can cost from $400.00 to $650.00 and even more. A European Skull Mount will cost up to and even above $300.00. The skull mount can be done by yourself or a taxidermist by boiling, scraping, cleaning and bleaching the skull. Or the skull can be cleaned, scraped, frozen and shipped to a skull cleaning company to do the job with beetles. This process can take as long as a year to complete.

The European Skull Mount is a very common way of preserving one's trophy in Europe and other parts of the world. It is gaining popularity here in the USA due to lower cost and also the new look. The problem with a skull mount is the bones can loosen and come apart with age and sometimes the teeth will even fall out. Another problem is when the skull is hung straight on the wall, the antlers face in a downward direction, giving them an unnatural look. This can be corrected with a special wall plaque, but the plaque can cost from $30.00 to $65.00 extra. Thus there is a need for a better and more effective European Skull Mounting system.

### SUMMARY OF THE INVENTION

The present disclosure concerns various aspects of a plastic skull mount or skull plate and a method of manufacturing them including a rotating ball and socket system for attaching, adjusting and locking antlers in place; and a positioning system apparatus and method for hanging a skull mount at approximately 45 degree angle with respect to a wall, thereby providing a more natural looking display.

This invention provides an effective and economical way of making a plastic or synthetic copy of a skull to make a skull mount like the European Skull Mount that is very realistic looking, and includes a special system for attaching antlers and adjusting them, and a way of locking the antlers in place, and a way of hanging the skull on the wall at approximately 45 degree angle, which displays the antlers better. The attachment system can either be fixed or removable. With the fixed system the antlers are locked in place permanently. With the removable system, a tapered rod and tapered sleeve are used. The tapered rod makes it easy for the tapered sleeve to go on, but when the sleeve is flushed or bottomed out on the tapered pin it fits very tight. This invention also is a way of making a skull plate that is realistic looking and has the same adjustable ball and socket system as the skull. This invention is also a method of manufacturing the inventive skull mount products.

The present invention takes all the previous attempts and drawbacks to a skull mount in consideration. The present invention is so realistic looking most people cannot tell it from a real bone skull from only a few feet away. It is made out of a very hard plastic that will never rot or come apart. It has a very easy antler mounting system that is completely adjustable and a way of locking the antlers in place. The invention has a built in positioning system that makes the skull hang at approximately 45 degree angle to the wall, which is a more natural looking because it approximates a normal head position for a live animal. This mounting angle change also changes the view of antlers attached to the skull, thereby giving them a more natural look. No additional wall plaque is needed.

### BRIEF DESCRIPTION OF THE DRAWINGS

FIG. 1 is a side view of the ball master.

FIG. 2 is a side cross-section view showing the ball master in a cup, with a rubber mold formed around it.

FIG. 3 is a side view of one half of the rubber mold.

FIG. 4 is a top view of the rubber mold with the two halves separated.

FIG. 5 is an side view of the production rod and how it's made.

FIG. 6 is a side cross-section view of the rubber mold and how it holds the rod.

FIG. 7 is a side view of the ball and rod assembly after it is formed.

FIG. 8 is a side view of the almost finished ball and rod.

FIG. 9 is a side view of a tapered rod version of the ball and rod.

FIG. 10 is a side cross-section view of a tapered sleeve.

FIG. 10A is an end view of a tapered sleeve.

FIG. 11 is a front view of a bone skull and how it is prepared to be a master skull.

FIG. 12 is a side cross-section view of the ball and rod and how it is glued into a hole in the antler pedicle of the bone skull being prepared as a master skull.

FIG. 13 is a side view of the skull and the angle of the rod.

FIG. 14 is a back view of the bone skull being prepared as a master.

FIG. 15 is a front cross-section view of the master skull being used to make a skull mother mold around it.

FIG. 16 is a front view of a rubber skull mold held inside the mother mold shell which is prepared for pouring plastic into it.

FIG. 17 is an enlargement of the part of the skull rubber mold that holds the ball and rod.

FIG. 18 is a front view of the finished plastic skull with adjustable antler attachments built into it.

FIG. 19 is a partial perspective view of an antler base showing a hole drilled into it.

FIG. 20 is a view of the antler showing how it is adjustably attached to the skull pedicle.

FIG. 21 is a front view of the finished product showing how the attached antlers may be moved.

FIG. 22 is a side view of the finished product with our adjustable wall hanger system in use.

FIG. 23 is a side view of a skull showing a skull plate portion of it that is made with our adjustable antler attachment system.

### DETAILED DESCRIPTION OF THE INVENTION

The following description discloses at least one suitable method and material used to implement the invention(s), however the described embodiments are not to be considered absolutely limiting. Rather, in light of this disclosure, one of ordinary skill in the related arts may be led to determine other suitable materials and methods that may be functionally equivalent, and all such variations are intended to be within the scope of any invention(s) for which future claims will define the actual extent of the scope.

Our method starts by making a ball and rod assembly 124 as part of our special ball and socket system for mounting antlers to a skull. FIGS. 1-4 illustrate the first step of creating a mold to use for forming a plastic ball on a metal rod.

FIG. 1 shows a ball and rod master 107 that includes a master ball 100 and master rod 102 with a vent pipe ridge 106 formed along the side of the master rod 102. A cone 104 is attached between a planar support 108 and the master ball 100. The ball and rod master 107 may be a one-off item that is used to make one or more rubber molds 112, which will in turn be used in production to manufacture quantities of the actual ball and rod assemblies 124, as needed. Thus the ball and rod master 107 is hand crafted from any suitable materials and by using conventional crafting means and methods. The main requirements are that the master ball 100 must have a smooth firm spherical surface dimensioned the same as the desired production ball 105; and the master rod 102 is a straight rod of a length sufficient to extend radially outward from the ball at least as much as the production rod 103. Also, the master rod 102 must be attached so that it extends radially outward relative to the center of the (spherical) ball. The rod is preferably round, but doesn't have to be. In fact it could be any cross-section shape that will leave a hole 102′ in the mold 112 sufficient to snugly enclose and hold the production rod 103. If already available, a production ball and rod assembly 124 may be used with the addition of the cone 104 and ridge 106. If not, a solid ball bearing, or a ping pong ball, or the like could be used along with a solid rod in a drilled hole, or a tube with a long screw through it to attach to a threaded hole in the ball, etc. The cone could be hollow or have a long screw hole along its axis. The vent ridge 106 could be a nail shank glued onto the master rod 102, a toothpick or whatever will create an air vent channel. The forgoing are merely examples of many possible ways to make the ball and rod master 107. No doubt ordinary craftsmen will come up with their own ways to cobble together a suitable ball and rod master 107, especially in light of the description below that shows how the master is to be used.

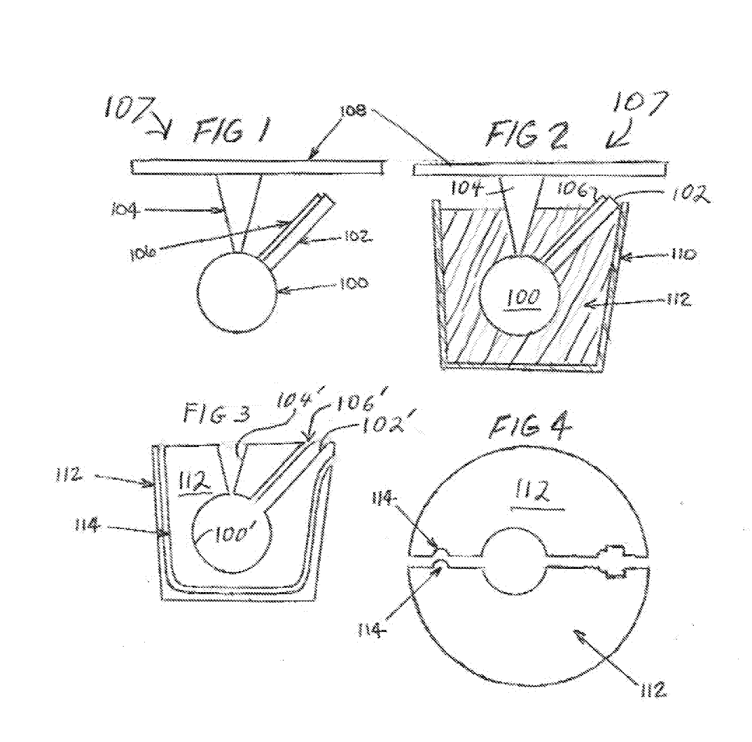

As shown in FIG. 2, the support 108 is used to suspend the ball and rod master 107 over a cup or container 110 while liquid rubber is poured in and then hardened to form a rubber “ball mold” 112.

Referring to FIG. 3, after the rubber hardens, the container 110 is removed and the hardened rubber is cut so that the ball and rod master 107 can be removed to leave a hollow ball mold 112. The cone 104 has formed a funnel 104′ leading into a ball-shaped interior cavity 100′ formed around the ball 100, and the vent pipe ridge 106 has formed an air vent line 106′ alongside a tubular hole 102′ made by the master rod 102.

FIG. 3 is a side view of one half of the ball mold 112 after it has been cut according to our method. In order to easily remove the ball and rod master 107, the hardened rubber is cut approximately in half along a plane passing through the master ball 100, the cone 104, and the length of both the master rod 102 and the vent pipe ridge 106.

FIGS. 3-4 also show our special male and female cut 114 that is formed in the mold 112. This male and female cut 114 is formed by cutting the rubber in half using a special knife, made especially for this purpose. This special cut allows the two halves of the rubber mold 112 to union or line up exactly the same way each time the mold 112 is used. Although not illustrated, it can be seen that an embodiment of our special knife may have an elongated flat blade that extends longitudinally outward from a handle, and is planar except for a semicircular bend out of the plane which has a cylindrical axis oriented transverse to the length of the blade.

FIG. 4 shows a top view of both halves of the rubber ball mold 112, and how the special male and female cut 114 unites, holding the two halves in perfect aliment when pressed together.

FIGS. 5-9 illustrate the process of forming our ball and rod assembly 124 in two embodiments.

FIG. 5 is a view of a steel rod 103 showing notches 118 cut into the rod to secure a plastic ball 105 that will be formed on the rod 103 (also see FIGS. 8 and 9). This will form a mechanical lock, making sure the rod 103 never slips, rotates within, or comes detached from the ball 105 of the assembly 124. The outside end 116 of the rod 103 is beveled, making it easier to press into a hole for attaching to an antler.

FIG. 6 is a side cross-sectional view showing one half of the ball mold 112, in a container 110, and how the steel rod 103 is placed in the ball mold 112 along the tubular hole 102′. When the two halves of the ball mold 112 are put together and held by replacing them in the container 110, they hold the steel rod 103 in place while plastic is poured into the ball mold 112 through the funnel 104′. The air vent pipe 106′ allows air to escape from the cavity 100′ when pouring the plastic into the ball mold 112. If the air is not allowed to escape there will air bubbles in the finished ball 105.

FIG. 7 shows the ball and rod 124 when it comes out of the ball mold 112. Note the plastic funnel shape 120 looks just like the cone 104 on the ball master 107, and the shape 122 formed up the side of the steel rod 103 looks like the vent pipe ridge 106. Both these shapes have to be removed, as shown in FIG. 8, and any remaining bumps 120′ and 122′ have to be smoothed, so they won't keep the ball 105 from rotating when it is incorporated in the finished skull 172 (FIG. 18).

It may be noted that the size of the rod and ball assembly 124 may need to vary depending on the size of the animal's skull and antlers. For example, there could be a few standard sizes used to cover the expected range, like “small, medium and large”.

FIG. 9 shows a variation 124′ of the ball and rod assembly that is used in our removable antler system. A special tapered rod 126 is formed from plastic molded over the steel rod 103 along with the ball 105. The tapered rod 126 is square in cross-section with a uniform taper on each side. The rod 103 provides the necessary strength, and the taper is easily formed by molding a unitary piece of plastic that includes both the tapered rod 126 and the ball 105. (Corresponding modifications to the mold 112 would be made to do this.)

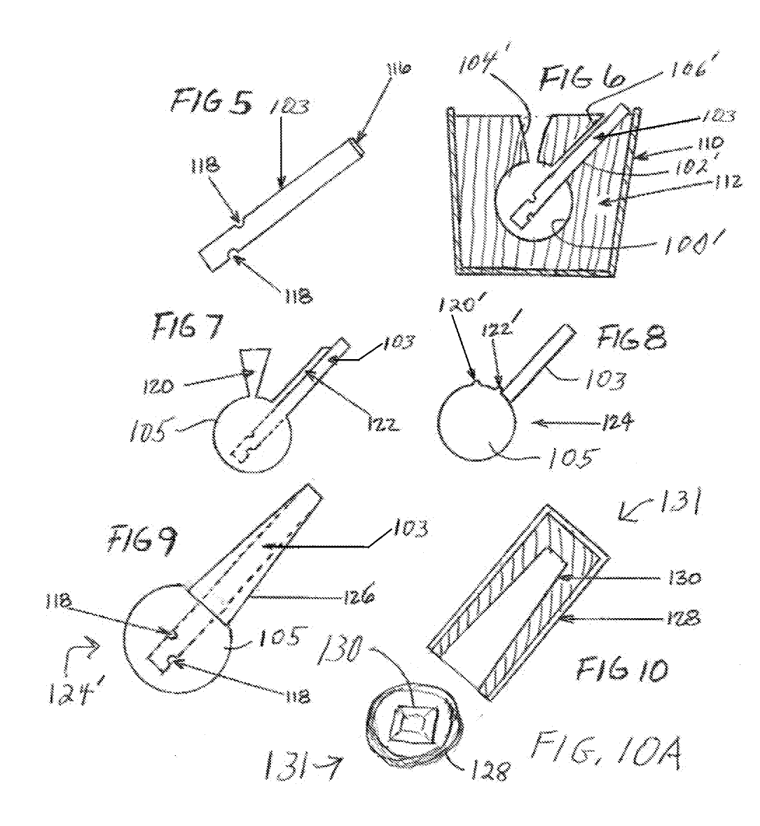

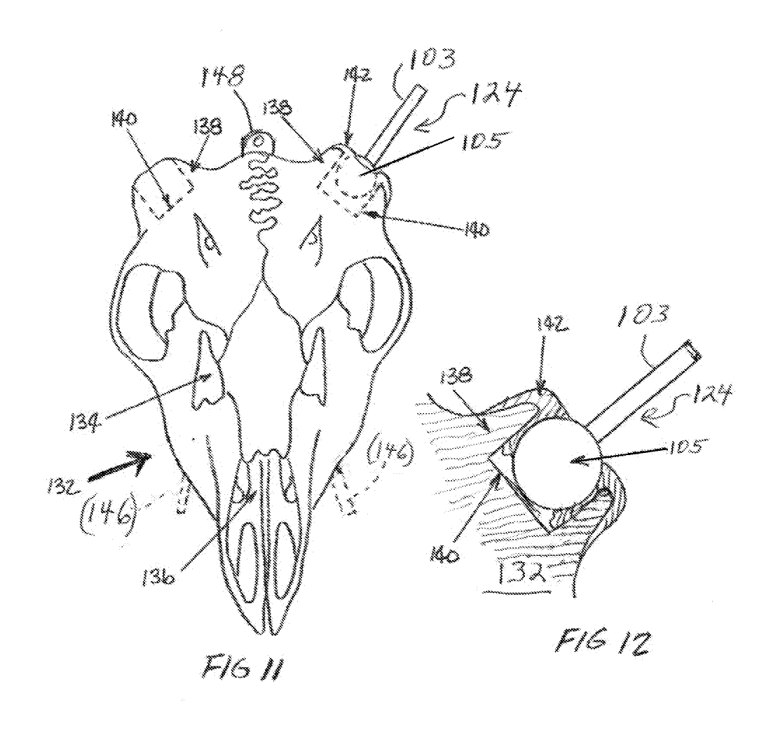

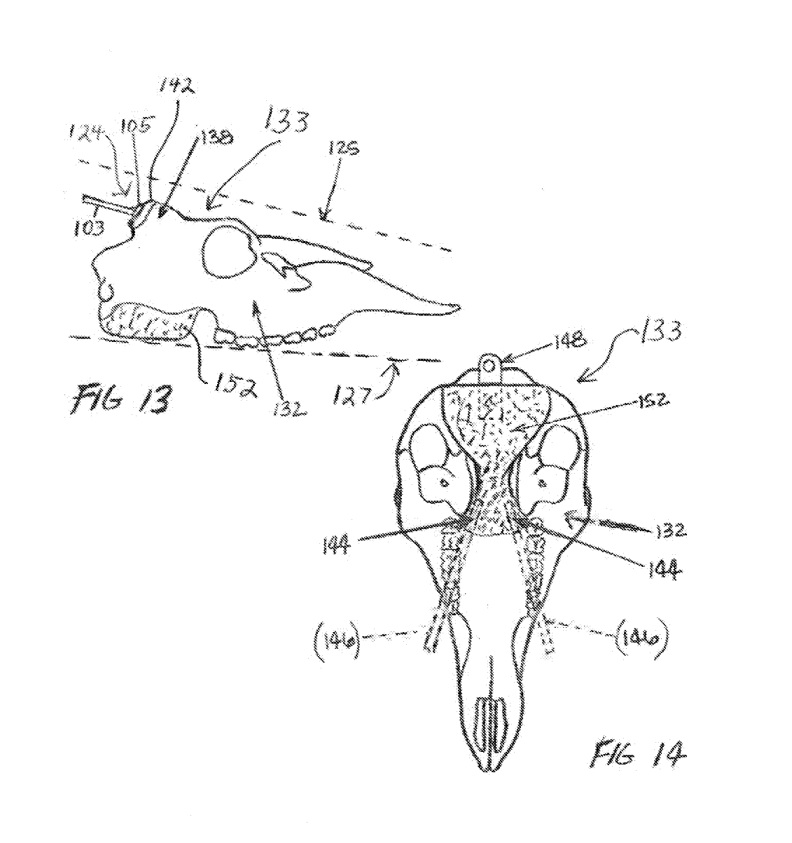

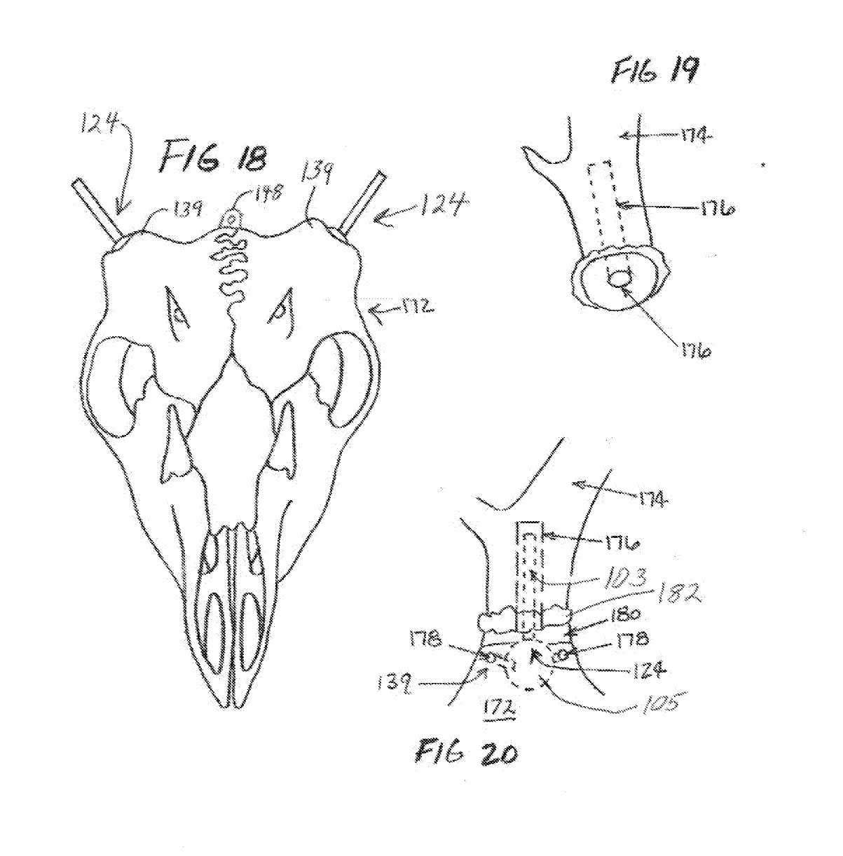

As shown in FIG. 10, a matching tapered hole 130 is formed inside a sleeve 128 to make a tapered socket 131. This sleeve 128 can be plastic or metal, for example. The tapered socket 131 is placed and locked into a hole 176 drilled in the bottom of an antler 174 as shown in FIG. 19. Unlike the standard rod 103 that is attached permanently in the antler (e.g., glued in the hole 176 as shown in FIG. 20), the tapered socket 131 is attached to the antler in the hole 176 instead. The special tapered shape of rod 126 and the matching shaped hole 130 allows the antler 174 to be removed and replaced very easily, but the taper is enough to cause a “jam fit” sufficient to hold the antler while on display. This is handy for someone who is moving the skull 172 and antlers 174 for display in different locations. The product is more compact and less subject to breakage when the antlers 174 are disconnected from the skull 172.

The taper 130 inside the sleeve 128 has to be close to the same as the taper on the tapered rod 126. The tapered socket 131 can be made by molding liquid plastic around a greased master of the tapered rod 126 placed inside a metal sleeve 128, or by casting in a mold as a solid plastic part with a tapered hole 130 inside. The sleeve part 128 is a convenience, not a necessary part of the tapered socket 131. FIG. 10A shows that the hole 130 has a square cross-section to match the shape of the tapered rod 126.

FIGS. 11-18 illustrate our process for making a real-looking plastic replica 172 of a bone skull while incorporating our ball and socket 124 adjustable antler mounting system in it, plus our wall mounting and table viewing features. To summarize, a bone skull 132 is specially prepared to be a skull master 133 suitable for making a corresponding rubber mold 168 for filling with plastic. Special aspects of the process include making a hard outer mold shell 154 to minimize the amount of rubber used in the mold, and then to support the rubber mold in a perfect 3-D position while it is filled with plastic. We also include a way to hold the previously prepared ball and rod assemblies 124 so that the ball 105 portion of it will be rotatably held in a surrounding ball socket integrally formed in the plastic skull 172.

FIG. 11 depicts a bone skull 132 (the actual trophy animal's skull), and shows how it is prepared to be a skull master 133 that can be used to form a rubber mold 168 around it. Every detail of the visible outside of the bone skull 132 must be perfected on the bone skull 132 to make it suitable for use as a skull master 133, because we want the finished plastic skull 172 to look just like the master 133, down to every crack and wrinkle.

First take the real bone skull 132 that is going to be used to make the master. Partly fill some of the small holes 134 and the upper part of the nasal cavities 136 to eliminate undercut places where the rubber could form a mechanical lock that would keep the rubber mold from releasing. Do as little alteration as possible to the front surfaces of the bone skull 132 so as not to affect the natural look and appearance of the finished product.

FIG. 12 is an enlargement showing how a master ball and rod 124 is positioned in the antler pedicle 138. The antler pedicle 138 is the raised boney part of the skull where the antler attaches to the skull 132. Drill holes 140 in the antler pedicle 138 large enough to hold the ball 105 as shown. Build up around the ball 105 with epoxy 142 to trap and lock the ball 124 in place, but leave some of the ball's top exposed (to allow tilting movement).

FIG. 13 a side view of the skull master 133, and it shows the angle 125 of the rod 103 of the ball and rod 124 when it is positioned properly in the pedicle 138. The angle 125 is very important to be able to get the right angle on the antlers after they have been attached. As shown, the angle 125 is in line with the overall slope of the front of the bone skull 132.

FIG. 14 is a back view of the bone skull 132 after it has been prepared as a skull master 133. FIGS. 13 and 14 show how the top back part of the bone skull 132 can be built up with epoxy to form a flat surface 152 that lines up with the line of teeth 127 on both sides. This flat surface 152 will help balance the finished skull 172 with antlers if it is set down on a horizontal surface like a table top or shelf.

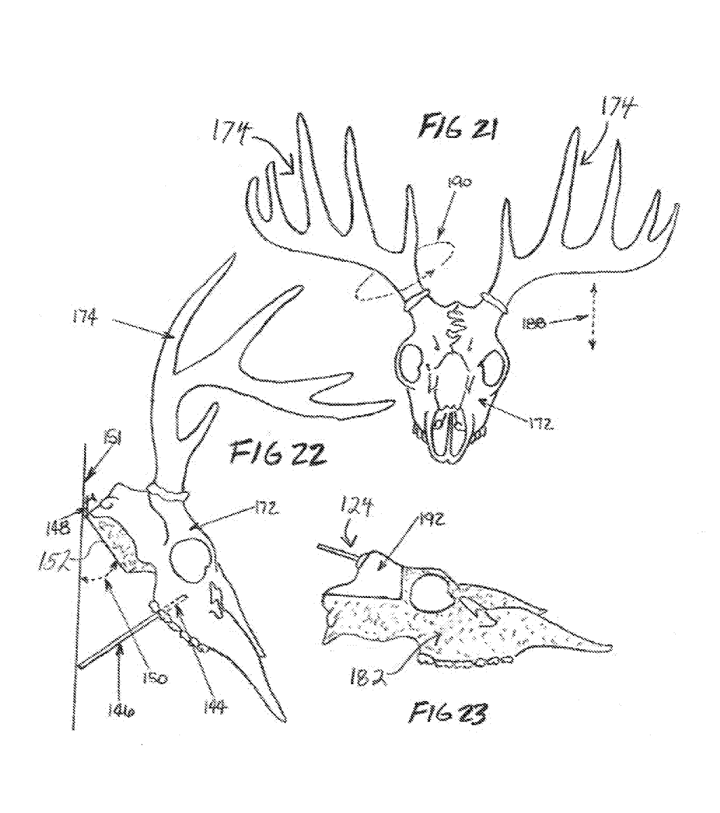

FIG. 14 also shows holes 144 drilled in the roof of the mouth (built up with epoxy as needed) and two rods 146. When the two rods 146 are placed into the holes 144 in the roof of the mouth, they form our wall mount positioning system. As shown in FIG. 22, the two rods 146 along with a hanger 148 act like a tripod to hold the finished product 172 at an approximately 45 degree angle 150 when hung on a wall 151. The angle 150 can be changed simply by shortening the length of the rods 146. The rods 146 may be made of wood to make length adjustment easy, although they can be made from other materials.

The holes 144 are carefully positioned and drilled in the skull master 133 so that they can be molded into the plastic skull 172. Thus the careful positioning is only done once on the master 133, not on every finished plastic skull 172. The rods 146 are shown in FIG. 14 but note that they are not part of the skull master 133.

The hanger 148 (e.g., a metal strap with a hole) is embedded in the epoxy at the top of the flat surface 152 of the skull master 133. This is done so that when the rubber mold 168 is formed around the master 133, a slot will be formed in the rubber mold corresponding to the exposed part of the hanger 148. Then when a plastic skull 172 is to be created in the mold 168, a new hanger 148 is positioned in the molded-in rubber slot. The part of the hanger that doesn't fit in the slot sticks out into the mold cavity where it will be embedded in the plastic that is poured into the mold 168.

FIG. 15 is a front cross-sectional view of a skull mother mold 154 (a hard shell with flanges 171 for bolting together as shown in FIG. 16) and how it is made. A threaded rod 160 is secured in the top of the master skull 133, and is attached to hang from a board 162. This will hold the skull 132 secure while the mold is being made around and on it. First the master skull 133 is covered with a layer of aluminum foil 156. The aluminum foil 156 will protect the master skull 133 and keep the clay 158 from sticking. Second a layer of clay 158 is applied in a ⅜ to ½ inch layer over the foil covered skull 133. The clay 158 is a sacrificial layer that will be replaced by rubber, so its shape will mainly determine the thickness of the rubber skull mold 168. Finally the outer shell (mother mold) 154 is hand formed all over the clay layer. Relatively fast curing epoxy is used, layered on with seams placed strategically for flanges 171 to be created where, later, the rubber mold 168 in the outer shell 154 will be separated to remove a molded plastic skull.

A bowl shaped base 164 is formed at the bottom of the skull mother mold 154. As shown in FIG. 16, this base 164 will later support the skull mother mold 154 in a upright position, so that plastic can be poured in to form the final product 172.

The rubber skull mold 168 is formed next. Still referring to FIG. 15, after the epoxy hardens and cures to form a hard outer shell 154, it is opened at the flanged seams 171, and removed from around the master skull 132. The layer of clay 158 and the aluminum foil 156 are completely removed and cleaned off of the master skull 133 and shell 154 surfaces, and then the master skull 133 is placed back inside the skull mother mold 154, and the flanges 171 are clamped together 174. A pouring hole 166 has been cut in the hanger board 162. This hole 166 will be used to pour liquid rubber into the space between the master skull 133 and the skull mother mold 154 (i.e., into the space formerly filled with clay and aluminum foil) to form the rubber skull mold 168. A small air vent hole 170 is also drilled into the hanger board 162 to let air escape when rubber is poured in through the pouring hole 166.

Still referring to FIG. 15, except noting that the layers 156 and 158 are now simply empty space, liquid rubber is poured into the skull mother mold 154 to fill the space where the clay 158 was. The liquid rubber is in direct contact with all surfaces of the master skull 133, and hardens into a layer around it to form the rubber skull mold 168 inside the outer shell 154.

After the rubber is hardened, the mother mold shell 154 is opened again, but this time the rubber layer has to be cut away from the master skull 133 very carefully to preserve the skull's surface texture, shapes, and cavities or holes as they are replicated on the inside of the rubber layer 168.

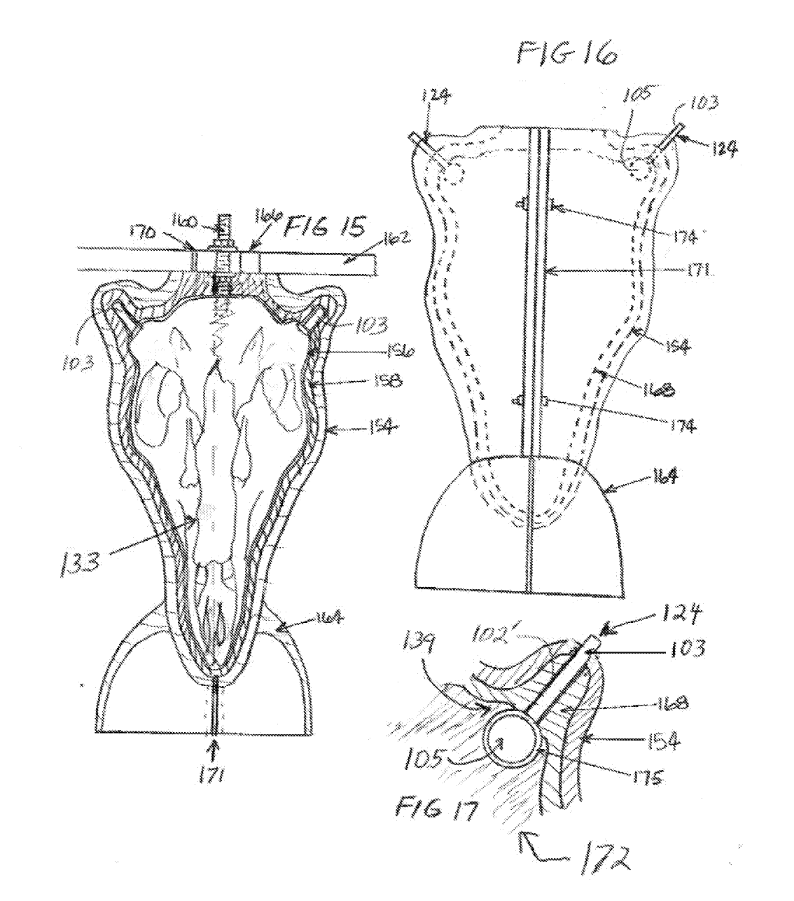

Now the master skull 132 is set aside and the rubber skull mold 168 is placed back in its supporting mother mold shell 154. Next, two previously made ball and rod assemblies 124 are placed in the rubber skull mold 168 and held in place by the tubular rod holes 102′ until the liquid plastic is poured in and hardened (see FIG. 17). Similarly, as explained above, a new hanger 148 is positioned in the slot that was molded into the rubber. It may be noted that since the skull master 133 did not include rods 146 in the holes 144, the rubber mold will have rod-like fingers protruding into the central cavity to form holes 144 in the molded plastic skull 172.

Finally the two halves of the skull mother mold 154 are brought together and locked in place with bolts 174 or clamps across the flanges 171. FIG. 16 is a front view of the reassembled skull mother mold 154 ready for pouring plastic into the top through a filling hole left in the rubber by the threaded rod 160. The rubber skull mold 168, which exactly conforms to the inside of the mother mold shell 154 is therefor held perfectly in place while liquid plastic is poured in to fill the space where the skull master 133 was, to form the final product, a very realistic looking plastic skull 172.

The best plastic we've found so far is a liquid urethane, 2-part plastic called “Smooth-Cast® 300 Series Bright White Liquid Plastic” sourced from Smooth-On Inc. of Easton, Pa.

FIG. 17 is an enlargement of the area in the skull mother mold 154 and the rubber mold 168 where the ball and rod assembly 124 was placed. The friction of the rubber in the hole 102′ of the skull rubber mold 168 holds the rod 103 of the ball and rod 124 in place while the plastic is poured into the rubber skull mold 168. The liquid plastic forms and hardens as a plastic pedicle 139 containing a spherical socket around the ball 105 that locks it into the finished plastic skull 172. A light coat of wax 175 is applied to the ball 105 so the liquid plastic will not stick to the plastic ball 105 when it hardens to form a socket for the ball 105. By comparing FIGS. 15-17, it can be seen that the ball 105 insertion depth into the plastic pedicle 139 can be controlled in several different ways. In FIG. 15, the rod 103 is fully contained in a blind hole which provides a convenient end-stop. In FIGS. 16 and 17, the rod protrudes outside the mold parts but as best seen in FIG. 17, the ball and rod assembly 124 is inserted in the rubber mold hole 102′ and pushed until the ball 105 is pressed up against the inside surface of the rubber mold 168. In this way, the length of the rod 103 outside of the ball 105 in either the skull master's rod or the production rod is not a critical factor.

FIG. 18 is a front view of the finished product 172. Having been formed in a mold 168 made from the original animal skull 132 (prepared to be the master skull 133), it looks just like the original but is made from plastic. Every little detail is captured by the rubber skull mold 168 and is therefor formed into the final product 172.

FIG. 19 is a side-bottom perspective view of an antler 174. A hole 176 is drilled into the bottom of the antler 174 slightly larger than the rod 103 on the ball and rod unit 124 and about a quarter inch deeper than the length of the rod 103 above the ball 105.

FIG. 20 shows how the rod 103 is placed into the hole 176 in the antler. The rod 103 is locked into the antler 174 with epoxy. After the epoxy hardens, the antlers 174 are adjusted and locked into place with set screws 178 tightened down on the ball 105. The final step is to fill the gap between antler 174 and pedicle 139 by adding a white putty 180 under the antler bun 182 at the top of the pedicle 139, filling in to hide any exposed parts of the ball and rod assembly 124.

FIG. 21 is a front view of the finished plastic skull 172 with antlers 174 attached. It shows how the antlers 174 can be tilted forward, back, up or down 188, and/or rotated 190.

FIG. 22 is a is a side view of the finished product 172. It shows the hanger 148 that holds the product 172 on the wall 151, and the built up area 152 at the base of the skull. It shows the holes 144 in the roof of the mouth, and the rods 146 that have been pushed into the holes 144, when the product is to be hung on a wall 151. This view shows how the two rods 146 and the hanger 148 form a stable tripod positioning system that hangs the finished product 172 at an approximate 45 degree angle 150 on the wall 151. Preferably the rods 146 are wooden because they can be stained a nice color, and they are easy to cut to a different length for adjusting the hanging angle 150.

FIG. 23 is a side view of a skull showing a top left portion of it called a “skull plate” that can be cut away from it. In a common example of their use, taxidermists use a specially reinforced bone, or an artificial molded skull plate that is capable of holding antlers for a preserved animal head. Then they will attach the skull plate with antlers to a Styrofoam head form 182 and cover everything with a hide “cape”, ideally using the actual antlers and hide cape from a trophy animal that is being “stuffed” by the taxidermist for wall mounting.

Various ways to attach antlers to a skull plate have been described in the background, but they all need improvement, especially if adjustable antler positioning is desired. Our inventive solution is to make just the “skull plate” portion of our plastic adjustable skull product 172. Thus our adjustable skull plate 192 is an appropriately cut-away top potion of the skull 172 with our special ball and socket 124 adjustable antler attachment system included. Antlers 174 can be attached and adjusted and locked in place the same way as with the whole skull 172.

What is claimed is:

1. A method for wall mounting a skull with adjustable antler orientation, comprising the step of:
making a plastic skull molded in a rubber mold that was formed around a real skull.
